(19) United States
(12) Patent Application Publication
(10) Pub. No.: US 2011/0226507 A1
(43) Pub. Date: Sep. 22, 2011

(54) TRANSMISSION CABLE AND SIGNAL TRANSMISSION CABLE USING THE SAME

(75) Inventors: Sho UEDA, Yotsukaido-shi (JP); Yoshinori SATOH, Sakura-shi (JP)

(73) Assignee: FUJIKURA LTD., Tokyo (JP)

(21) Appl. No.: 13/150,745

(22) Filed: Jun. 1, 2011

Related U.S. Application Data
(63) Continuation of application No. PCT/JP2009/070019, filed on Nov. 27, 2009.

(30) Foreign Application Priority Data
Dec. 2, 2008 (JP) 2008-307348

(51) Int. Cl. H01B 11/00

(52) U.S. Cl. 174/106 R

(57) ABSTRACT

A transmission cable 10 includes a base cable 18 including at least one cable core 16, and an external conductor 20 provided on the outer periphery of the base cable 18. The at least one cable core 16 includes an internal conductor 12, and an insulating layer 14 provided on the outer periphery of the internal conductor 12 and made of resin. The external conductor 20 is formed on the outer periphery of the base cable 18. The external conductor 20 includes a first conductor layer 24 provided on the surface of the insulating layer 14, and a second conductor layer 26 provided on the outer periphery of the fist conductor layer 24 and formed by electrolytic plating.

This is a continuation application based on PCT application No. PCT/JP2009/070019 filed Nov. 27, 2009, which claims priority to JP 2008-307348 filed Dec. 2, 2008, the contents of which are incorporated herein by reference.

### BACKGROUND ART

The present invention relates to a transmission cable and a signal transmission cable using the transmission cable.

In recent years, multifunctional electronic devices in various types of communication devices and computers have been developed rapidly. With the development of multifunctionality, a large number of IC chips have been installed in such an electronic device. In addition, as a transmission capacity becomes larger, a transmission speed becomes faster. Under such circumstances, a transmission frequency of an electric signal in the electronic device tends to become higher. At the same time, as the transmission frequency becomes higher, electric signal noise in the electronic device increases. Therefore, an internal wiring as a transmission medium in the electric signal is required to have a good shielding property with respect to electromagnetic waves. As a cable having an improved shielding property, Japanese Patent Application Laid-Open Publication No. 2005-285696 discloses a duplex parallel coaxial cable.

### SUMMARY OF INVENTION

A common transmission cable such as a coaxial cable includes an internal conductor, an insulator provided on the outer periphery of the internal conductor, and an external conductor provided on the outer periphery of the insulator. The external conductor has a function to shield electromagnetic waves. The external conductor is composed of a metal braid or metal tape, for example. The metal braid or metal tape is wound around the insulator in a state of longitudinal lapping or spiral winding. The “longitudinal lapping” is a method in which the metal braid or metal tape having a width large enough to encircle the insulator is placed in parallel to an axis direction of the insulator and bent into a cylindrical layer around the axis of the insulator.

However, a lot of gaps may be caused inside the external conductor when the metal braid or metal tape is only wound around the insulator in a stage of longitudinal lapping or spiral winding. In such a case, an electromagnetic shielding effect may not be sufficiently obtained.

It is an object of the present invention to provide a transmission cable having an improved electromagnetic shielding effect, and a signal transmission cable using the transmission cable.

A transmission cable according to a first aspect of the present invention comprises: a base cable including at least one cable core having an internal conductor and an insulating layer provided on an outer periphery of the internal conductor and made of resin; and an external conductor provided on an outer periphery of the base cable. The external conductor comprises: a first conductor layer provided on the outer periphery of the base cable and made of an electrically conductive material; and a second conductor layer provided on an outer periphery of the first conductor layer and formed by electrolytic plating.

The first conductor layer is preferably an electroless plating layer of copper, nickel or gold formed on the outer periphery of the base cable.

The insulating layer may include a first isolated foam layer.

The insulating layer may further include a non-foam layer. In this case, the first isolated foam layer is provided adjacent to the internal conductor. The non-foam layer is provided on an outer periphery of the first isolated foam layer.

The insulating layer may further include a second isolated foam layer. In this case, the first isolated foam layer is provided adjacent to the internal conductor. The second isolated foam layer is provided on the outer periphery of the first isolated foam layer. In addition, a degree of foaming of the first isolated foam layer is lower than that of the second isolated foam layer.

The insulating layer may further include an interconnected foam layer having cells that communicate with each other. In this case, the interconnected foam layer is provided adjacent to the internal conductor. The first isolated foam layer is provided on an outer periphery of the interconnected foam layer.

The insulating layer is preferably made of polyolefin resin.

The at least one cable core may include a plurality of cable cores.

A signal transmission cable according to a second aspect of the present invention comprises at least two transmission cables as described above.

According to the transmission cable having the above-described configuration and the signal transmission cable using the transmission cable, the external conductor is formed more densely. Therefore, the electromagnetic shielding effect can be improved.

### BRIEF DESCRIPTION OF DRAWINGS

FIG. 1 is a cross-sectional view of a transmission cable according to an embodiment of the present invention.

FIG. 2(a) to FIG. 2(c) are cross-sectional views of transmission cables having a plurality of cable cores according to an embodiment of the present invention. FIG. 2(a) shows a transmission cable having two cable cores, FIG. 2(b) shows a transmission cable having at least three cable cores, and FIG. 2(c) shows a transmission cable having at least four cable cores.

FIG. 3(a) to FIG. 3(d) are cross-sectional views showing a part of an insulating layer according to an embodiment of the present invention. FIG. 3(a) shows an insulating layer in a case of including an isolated foam layer, FIG. 3(b) shows an insulating layer in a case of including an isolated foam layer and a non-foam layer, FIG. 3(c) shows an insulating layer in a case of including two isolated foam layers, and FIG. 3(d) shows an insulating layer in a case of including an isolated foam layer and an interconnected foam layer.

FIG. 4(a) to FIG. 4(d) are cross-sectional views of base cables according to an embodiment of the present invention. FIG. 4(a) shows a base cable composed of one cable core, FIG. 4(b) shows a base cable composed of two cable cores, FIG. 4(c) shows a base cable composed of at least three cable cores, and FIG. 4(d) shows a base cable composed of at least four cable cores.

FIG. 5 is a cross-sectional view of a signal transmission cable according to an embodiment of the present invention.

### DESCRIPTION OF EMBODIMENTS

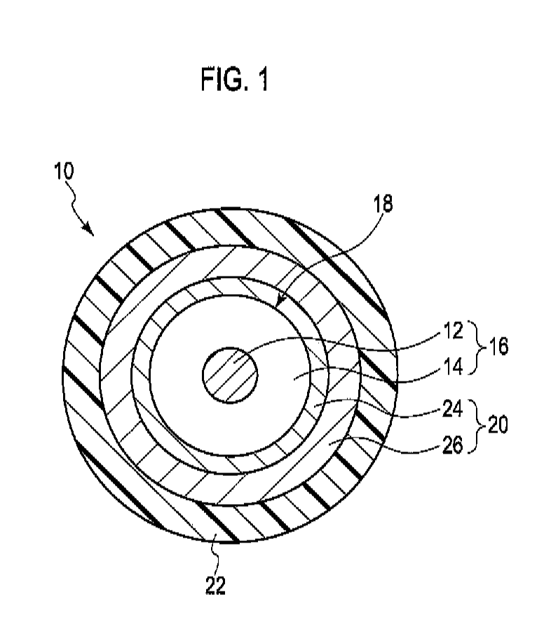

A description will be made below in detail of an embodiment of the present invention with reference to the drawings. FIG. 1 is a cross-sectional view showing a constitution of a transmission cable 10. FIG. 1 shows a cross-section in a direction approximately perpendicular to a cable direction of the transmission cable 10.

The transmission cable 10 includes a base cable (cable substrate) 18 including at least one cable core 16 having an internal conductor 12 and an insulating layer 14 provided on the outer periphery of the internal conductor 12, and an external conductor 20 provided on the outer periphery of the base cable 18. Preferably, an outer casing 22 is provided on the outer periphery of the external conductor 20.

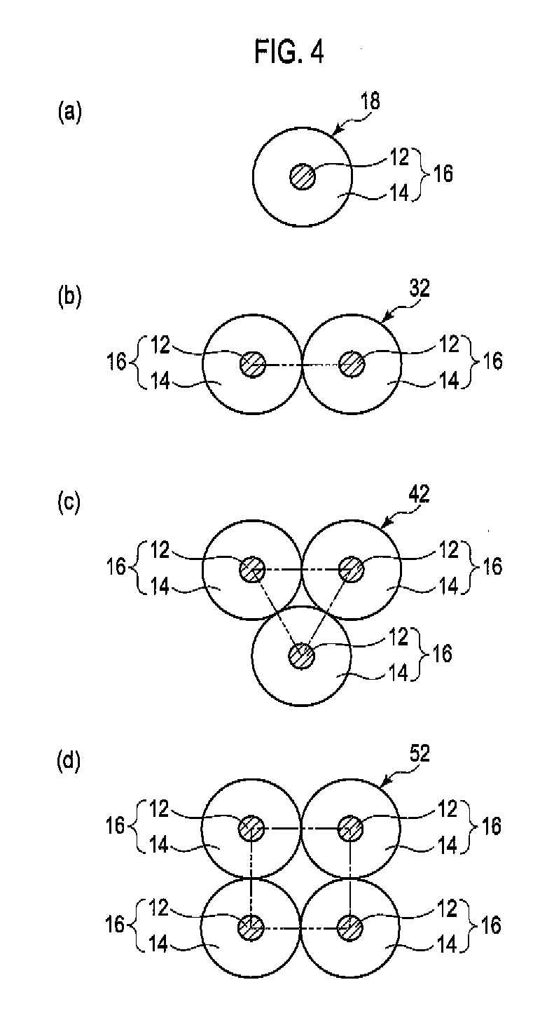

The base cable 18 includes at least one cable core 16. In other words, the base cable 10 is a cable provided with the cable core 16 as one component. Therefore, the base cable 18 is composed only of one cable core 16 (see FIG. 4(a)). However, as described below, the base cable 18 may be composed of a plurality of the cable cores 16 to be put together (see FIG. 4(b) to FIG. 4(d)).

The cable core 16 includes the internal conductor 12, and the insulating layer 14 provided on the outer periphery of the internal conductor 12 and made of resin.

The internal conductor 12 is composed of a solid conductor or a stranded conductor such as an annealed copper wire and a copper alloy wire, and has a function to transmit signal waves such as radio waves. The annealed copper wire and the copper alloy wire may be subjected to silver plating or tin plating. A diameter of the internal conductor 12 is within a range of AWG (American Wire Gauge) 26 to AWG 34, for example.

The insulating layer 14 is provided on the outer periphery of the internal conductor 12. The insulating layer 14 is made of resin, and has a function to electrically insulate the internal conductor 12 from outer members. The insulating layer 14 is formed to have an approximately circular shape in cross-section perpendicular to a longitudinal direction of the cable. The insulating layer 14 is formed by a molding method such as an extrusion molding method.

The resin composing the insulating layer 14 preferably has a relatively low relative permittivity and dielectric tangent. One example of the resin having such an electrical property is polyolefin resin. The polyolefin resin can prevent a reduction of an attenuation of the transmission cable 10. As for the polyolefin resin, the use of polyethylene resin or polypropylene resin is preferable. Particularly, the use of low-density polyethylene resin is more preferable.

A diameter of the insulating layer 14 may be 1.1 mm when a conductor line with a diameter of AWG 28 as the internal conductor 12 is used and the insulating layer 14 does not include an isolated foam layer or an interconnected foam layer described below. When the whole insulating layer 14 is composed of the isolated foam layer or the interconnected foam layer, the diameter may be 1.25 mm. When the insulating layer 14 has a double layer structure as described below, the diameter is within a range of the above-mentioned values. It is to be noted that these values vary depending on the properties of the transmission cable 10 (for example, a diameter or a strand count of the internal conductor 12, a permittivity of resin, the presence or absence of an isolated foam layer or an interconnected foam layer, impedance to be required, or the like, when the internal conductor 12 is composed of a solid conductor or composed of a stranded conductor). Thus, the diameter of the insulating layer 14 is not limited to the above-mentioned values.

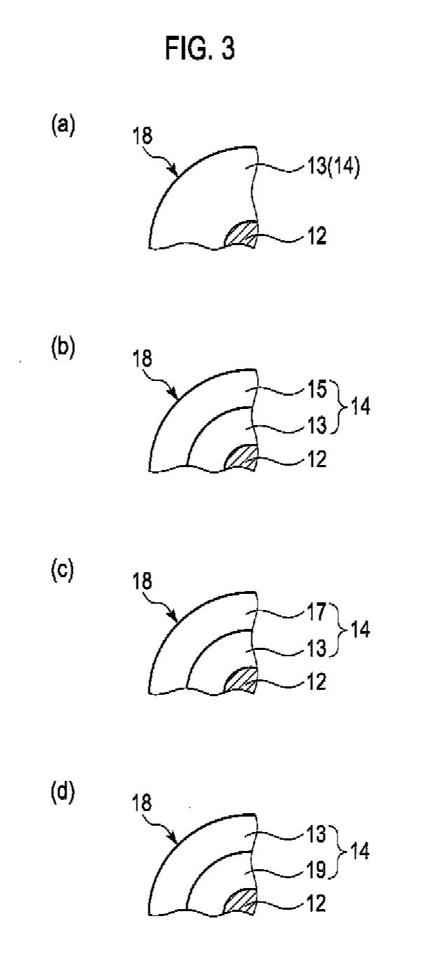

Hereinafter, the insulating layer 14 according to the present embodiment will be explained with reference to FIG. 3(a) to FIG. 3(d). Note that, a thickness of each layer and a configuration of the interface of each layer of FIG. 3(b) to FIG. 3(d) are not limited to those shown in the figures.

As shown in FIG. 3(a), the insulating layer 14 may include an isolated foam layer (first isolated foam layer) 13 having isolated cells (or closed cells). The “isolated cells” represent a plurality of cells that do not communicate with each other in foam such as foamed resin. In other words, the respective isolated cells are segmented by walls each isolated cell has. The isolated foam layer 13 composes the whole insulating layer 14. Alternatively, the isolated foam layer 13 composes a part of the insulating layer 14 as described below. In general, a relative permittivity and dielectric tangent of foamed resin are smaller than those of resin that is made of the same material but does not have cells. Therefore, a dielectric loss of the transmission cable 10 can be decreased due to the provision of the foam layer in the insulating layer 14.

When a degree of foaming in the isolated foam layer is defined as (1−density after foaming/density before foaming)×100, a degree of foaming in the isolated foam layer 13 is preferably 50% or less, more preferably within a range of 30% or more to 50% or less. For example, when a conductor line with a diameter between AWG 26 and AWG 34 is used for the internal conductor 12, a degree of foaming is preferably within a range of 30% or more to 40% or less. The isolated foam layer 13 having the degree of foaming of 50% or less has a higher mechanical strength than the isolated foam layer having the degree of foaming of more than 50%. Thus, when the isolated foam layer 13 has the degree of foaming of 50% or less, the insulating layer 14 may have an even outer diameter compared to the isolated foam layer having the degree of foaming of more than 50%. In addition, the isolated foam layer 13 having the degree of foaming of 30% or more may have a smaller relative permittivity and dielectric tangent than the isolated foam layer having the degree of foaming of less than 30%.

As shown, in FIG. 3(b), the insulating layer 14 may include the above-described isolated foam layer (first isolated foam layer) 13, and a non-foam layer 15 without cells. Namely, the insulating layer 14 may be composed of these two layers. In this case, the isolated foam layer 13 is provided adjacent to the internal conductor 12. The non-foam layer 15 is provided on the outer periphery of the isolated foam layer 13. Due to such a configuration, a reduction of the relative permittivity and dielectric tangent can be achieved by the isolated foam layer 13, and a desired mechanical strength can be ensured by the non-foam layer 15. Namely, a reduction effect of the dielectric loss of the transmission cable 10 can be improved while a desired mechanical strength of the insulating layer 14 is ensured.

As shown in FIG. 3(c), the insulating layer 14 may include the isolated foam layer (first isolated foam layer) 13 and an isolated foam layer (second isolated foam layer) 17, each of which has a different degree of foaming. For example, the isolated foam layer 13 is provided adjacent to the internal conductor 12, and the isolated foam layer 17 is provided on the outer periphery of the isolated foam layer 13. The degree of foaming of the isolated foam layer 17 is within a range of that set for the isolated foam layer 13, while the degree of foaming of the isolated foam layer 13 is set to be lower than that of the isolated foam layer 17. Due to such a configuration, a reduction of the relative permittivity and dielectric tangent can be achieved mainly by the isolated foam layer 13, and the mechanical strength can be ensured mainly by the isolated foam layer 17. Therefore, a reduction effect of the dielectric loss of the transmission cable 10 can be improved while the mechanical strength of the insulating layer 14 is ensured.

As shown in FIG. 3(d), the insulating layer 14 may include an interconnected foam layer 19 having interconnected cells (or open cells), and the above-described isolated foam layer (first isolated foam layer) 13. Namely, the insulating layer 14 may be composed of these two layers. In this case, the interconnected foam layer 19 is provided adjacent to the internal conductor 12, and the isolated foam layer 13 is provided on the outer periphery of the interconnected layer 19. The “interconnected cells” represent a plurality of cells that communicate with each other in foam such as foamed resin. The interconnected foam layer is porous foam, and capable of reducing a relative permittivity and dielectric tangent in the same manner as the above-described isolated foam layer. As described above, the isolated foam layer 13 is provided on the outer periphery of the interconnected foam layer 19. Since the periphery of the isolated foam layer has a smoother surface than that of the interconnected foam layer 19, the periphery of the insulating layer 14 may be subjected to metal plating in a dense state as described below.

Examples of a molding method of the isolated foam layers 13 and 17 include a chemical foam molding method and a gas foam molding method. In the chemical foam molding method, a foaming agent is supplied to an extruder together with polyolefin resin. Then, the foaming agent is thermally decomposed in the extruder, thereby generating gas. Then, the gas is mixed in the polyolefin resin under high pressure in the extruder. Thus, the polyolefin resin extruded from a die is foamed due to reduced pressure during the extrusion. Examples of the foaming agent include azodicarbonamide (ADCA) and 4,4′-oxybis(benzenesulfonyl hydrazide) (OBSH).

In the gas foam molding method, inert gas is supplied to the extruder at high pressure, so as to be mixed in polyolefin resin. Thus, the polyolefin resin extruded from a die is foamed due to reduced pressure during the extrusion. The inert gas is carbon dioxide and nitrogen gas, for example. The isolated foam layers 13 and 17 and the interconnected foam layer 19 according to the present embodiment are preferably formed by the gas foam molding method. This is because the chemical foam molding method has a possibility that a by-product generated by the decomposition of the foaming agent affects an attenuation of the cable caused by a dielectric loss or the like.

When the insulating layer 14 is composed of two layers, a tandem system or a common head system may be used for the formation of the two layers. In the tandem system, a first extruder and a second extruder are arranged in series in an extrusion direction. The first extruder forms a first layer, and thereafter, the second extruder forms a next layer. In the common head system, the first extruder and the second extruder that are connected to one head are used. This head includes an inner die and an outer die that are coaxially arranged, for example. The first extruder is connected to the inner die, and the second extruder is connected to the outer die. When the internal conductor 12 passes through the inner die, resin composing each layer by the extrusion from the respective first and second extruders is extruded from each die, thereby concurrently forming each layer on the outer periphery of the internal conductor 12.

The external conductor 20 includes a first conductor layer 24 formed on the outer periphery of the base cable 18, and a second conductor layer 26 provided on the outer periphery of the first conductor layer 24 and formed by electrolytic plating.

The first conductor layer 24 functions as a substrate to form the second conductor layer 26 on the surface of the base cable 18. In other words, the first conductor layer 24 is an electrically conductive film formed on the surface of the base cable 18. Preferable examples of the material of the first conductor layer 24 include copper, nickel and gold.

The transmission cable 10 shown in FIG. 1 is composed only of one cable core 16 (see FIG. 4(a)). Therefore, the first conductor layer 24 is formed on the whole outer periphery of the insulating layer 14 in the cable core 16.

The first conductor layer 24 may be formed by an electroless plating method. Common examples of the electroless plating method include an electroless copper plating method, an electroless nickel plating method and an electroless gold plating method. For example, in the case of an electroless copper plating treatment, a commercially-available electroless copper plating solution is used for electroless copper plating. The electroless copper plating solution includes copper sulfate, a reducing agent, a chelating agent, and a plating additive. Before the electroless plating treatment, a pretreatment such as a plasma treatment and a corona discharge treatment is preferably subjected to the surface of the insulating layer 14. The first conductor layer 24 may be also formed by a physical vapor deposition method (PVD method) such as a sputtering method, a vacuum vapor deposition method and an ion plating method, or a chemical vapor deposition method (CVD method).

When the insulating layer 14 does not include the above-described isolated foam layers 13 and 17 or the interconnected foam layer 19, a thickness of the first conductor layer 24 is preferably between 0.3 μm or more and 3 μm or less. When the thickness of the first conductor layer 24 is 0.3 μm or more, the first conductor layer 24 can ensure sufficient electrical conductivity during electrolytic plating for the second conductor layer 26. Although the first conductor layer 24 having the thickness of more than 3 μm ensures sufficient electrical conductivity, it takes a long time to form such a layer. As a result, a decrease in productivity may be caused.

When the insulating layer 14 includes isolated cells (see FIG. 3(a)), the insulating layer 14 may have a slightly rough surface. Therefore, in order that sufficient electrical conductivity for electrolytic plating for the second conductor layer 26 is applied reliably to the first conductor layer 24, the thickness of the first conductor layer 24 is preferably 10 μm or more. The cells present in the insulating layer 14 are isolated cells as described above. Thus, the first conductor layer 24 may be formed in a dense state on the outer periphery of the insulating layer 14 by the electroless plating or the physical vapor deposition method.

Alternatively, the first conductor layer 24 may be composed of a first metal layer (not shown in the figure) for improving adhesiveness to the insulating layer 14, and a second metal layer (not shown in the figure) formed on the first metal layer for improving affinity for the second conductor layer 26. For example, when the second conductor layer 26 is made of copper, the second metal layer is preferably made of copper.

The second conductor layer 26 is provided on the outer periphery of the first conductor layer 24 and formed by the electrolytic plating method. Namely, the second conductor layer 26 is a metal plating layer formed by the electrolytic plating method. Due to the formation of the second conductor layer 26 by the electrolytic plating, the second conductor layer 26 can be formed in a dense state. Therefore, the electromagnetic shielding effect of the transmission cable 10 can be further improved. The second conductor layer 26 is made of an electrically conductive material such as copper, gold, silver, tin and nickel.

When the second conductor layer 26 is formed by the electrolytic copper plating method, a copper sulfate plating bath may be used as an electrolytic copper plating bath used in this method. For example, the copper sulfate plating bath contains copper sulfate and a sulfuric acid as a main component, and further contains chloride ions and a plating additive. The electrolytic copper plating bath is not particularly limited to the copper sulfate plating bath, and other copper plating baths may be used.

A thickness of the second conductor layer 26 is preferably thicker than the thickness of the first conductor layer 24. More specifically, the thickness of the second conductor layer 26 is preferably between 20 μm or more and 50 μm or less. When the second conductor layer 26 has the thickness of 20 μm or more, a sufficient electromagnetic shielding effect can be ensured compared to a conductor layer having a thickness of less than 20 μm. Although the second conductor layer 26 having the thickness of more than 50 μm ensures a sufficient electromagnetic shielding effect, it takes a long time to form such a layer. As a result, a decrease in productivity may be caused.

The outer casing 22 is provided on the outer periphery of the second conductor layer 26, and has a function to protect the base cable 18. Examples of a material of the outer casing 22 include polyethylene resin, polypropylene resin, fluorine resin, and polyvinyl chloride resin. The outer casing 22 is formed by a molding method such as an extrusion molding method.

The following is an explanation of the transmission cable according to another embodiment of the present invention. Note that, the same elements as the above-described embodiment are indicated by the same reference numerals, and the specific explanations thereof will not be repeated.

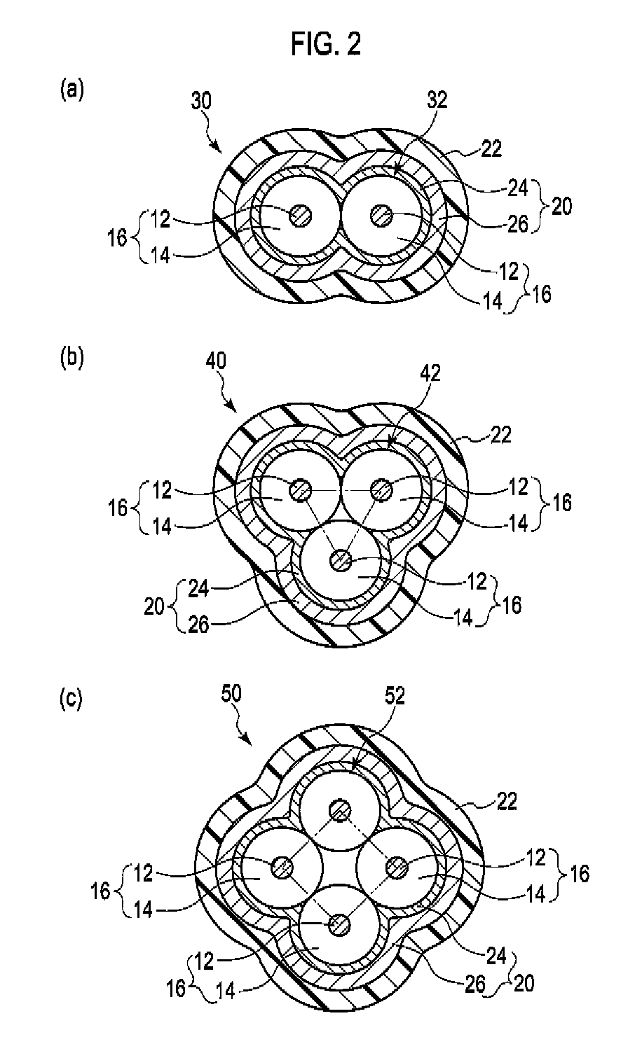

FIG. 2(a) to FIG. 2(c) are cross-sectional views of transmission cables 30, 40 and 50 having two or more cable cores 16. Each of FIG. 2(a) to FIG. 2(c) shows a cross-section in a direction approximately perpendicular to the cable direction of the respective transmission cables 30, 40 and 50, FIG. 4(b) to FIG. 4(d) show cross-sections of base cables 32, 42 and 52 composing the transmission cables 30, 40 and 50, respectively.

As shown in FIG. 2(a), the transmission cable 30 includes the base cable 32. The base cable 32 has two cable cores 16. The two cable cores 16 may be twisted together, or may be arranged linearly and approximately in parallel. As shown in FIG. 2(a) and FIG. 4(b), a distance between each center of the two cable cores 16 is preferably approximately equal to the diameter of the respective cable cores 16. In this case, the two cable cores 16 are in contact with each other. In particular, the insulating layers 14 of the two cable cores 16 are in contact with each other.

The periphery of the base cable 32 is provided with the first conductor layer 24. The first conductor layer 24 may be formed by electroless plating. Preferably, the first conductor layer 24 is not provided at a contact portion between the two cable cores 16. The periphery of the first conductor layer 24 is provided with the second conductor layer 26. The second conductor layer 26 is formed by electrolytic plating.

As shown in FIG. 2(b), the transmission cable 40 includes the base cable 42. The base cable 42 has at least three cable cores 16. The at least three cable cores 16 may be twisted together, or may be arranged linearly and approximately in parallel.

In the base cable 42, the cable cores 16 are preferably provided in such a manner that each center of the internal conductors 12 of the cable cores 16 is located at each vertex of an equilateral triangle in a cross-section approximately perpendicular to the cable direction. A length of one side of the equilateral triangle is approximately equal to the diameter of the respective cable cores 16. For example, when the base cable 42 includes four cable cores 16, the respective internal conductors 12 are located at each vertex of two equilateral triangles that have one side in common in the above-mentioned cross-section (see FIG. 2(b) and FIG. 4(c)). The adjacent cable cores 16 are in contact with each other. In particular, the insulating layers 14 of the adjacent two cable cores 16 are in contact with each other.

Similar to the base cables 18 and 32 of the transmission cables 10 and 30, the periphery of the base cable 42 is provided with the first conductor layer 24. The first conductor layer 24 may be formed by electroless plating. Preferably, the first conductor layer 24 is not provided at each contact portion between the adjacent cable cores 16, and the inner periphery of the base cable 42 (that is, the surfaces of the cable cores 16 including in a space having a cross-section of the equilateral triangle).

Similar to the base cables 18 and 32 of the transmission cables 10 and 30, the periphery of the first conductor layer 24 is provided with the second conductor layer 26. The second conductor layer 26 is formed by electrolytic plating.

As shown in FIG. 2(c), the transmission cable 50 includes the base cable 52. The base cable 52 has at least four cable cores. The at least four cable cores 16 may be twisted together, or may be arranged linearly and approximately in parallel. In the base cable 52, the cable cores 16 are preferably provided in such a manner that each center of the internal conductors 12 of the cable cores 16 is located at each vertex of a square in a cross-section approximately perpendicular to the cable direction. A length of one side of the square is approximately equal to the diameter of the respective cable cores 16. For example, when the base cable 52 includes six cable cores 16, the respective internal conductors 12 are located at each vertex of two squares that have one side in common in the above-mentioned cross-section (see FIG. 2(c) and FIG. 4(d)). The adjacent cable cores 16 are in contact with each other. In particular, the insulating layers 14 of the adjacent two cable cores 16 are in contact with each other.

Similar to the base cables 18, 32 and 42 of the transmission cables 10, 30 and 40, the periphery of the base cable 42 is provided with the first conductor layer 24. The first conductor layer 24 may be formed by electroless plating. Preferably, the first conductor layer 24 is not provided at each contact portion between the adjacent cable cores 16, and the inner periphery of the base cable 52 (that is, the surfaces of the cable cores 16 including in a space having a cross-section of the square).

Similar to the base cables 18, 32 and 42 of the transmission cables 10, 30 and 40, the periphery of the first conductor layer 24 is provided with the second conductor layer 26. The second conductor layer 26 is formed by electrolytic plating.

The periphery of the external conductor 20 of the respective transmission cables 30, 40 and 50 is preferably provided with the outer casing 22. The outer casing 22 is made of resin such as polyvinyl chloride resin, and protects the external conductor 20 and the respective base cables 32, 42 and 52.

The following is an explanation of the signal transmission cable. Note that the same elements as the above-described embodiments are indicated by the same reference numerals, and the specific explanations thereof will not be repeated.

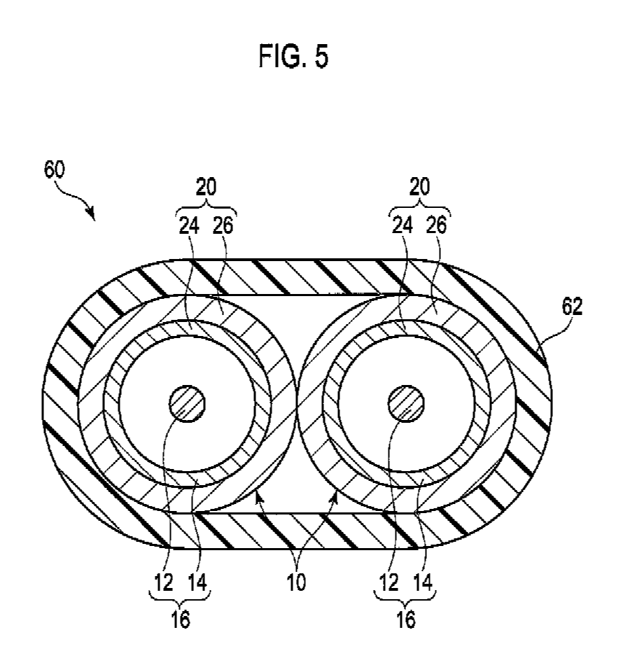

FIG. 5 is a cross-sectional view of a signal transmission cable 60. FIG. 5 shows a cross-section of the signal transmission cable 60 in a direction approximately perpendicular to the cable direction. The signal transmission cable 60 is used as a differential signal transmission cable. The signal transmission cable 60 is composed of the transmission cables 10 that are twisted together without the outer casing 22. The number of the transmission cables 10 to be used is two or more. The periphery of the transmission cables 10 twisted together is provided with a protection layer 62. Examples of resin composing the protection layer 62 include polyethylene resin, polypropylene resin, fluorine resin, and polyvinyl chloride resin, similar to the outer casing 22 of the transmission cable 10. The transmission cables to be used in the signal transmission cable 60 may be the transmission cables 30, 40 or 50 without the outer casing 22, instead of the transmission cables 10.

In the respective transmission cables, the external conductor is formed on the outer periphery of the base cable. In particular, the external conductor includes the first conductor layer provided on the surface of the insulating layer, and the second conductor layer provided on the outer periphery of the first conductor layer and formed by electrolytic plating. The external conductors according to the respective embodiments of the present invention are formed in a denser state than an external conductor to be formed in such a manner that a metal braid or metal tape is wound around the external conductor. Accordingly, an electromagnetic shielding effect can be improved.

The external conductor in the transmission cable according to the present embodiment is formed by plating. Due to the formation of the external conductor by plating, misalignment between the external conductor and the internal members (that is, the internal conductor and the insulating layer) of the external conductor can be suppressed compared to the case of an external conductor to be formed in such a manner that a metal braid or metal tape is wound around the external conductor. Therefore, stable impedance can be ensured in the transmission cable including the external conductor formed by plating.

The external conductor according to the present embodiment has fewer processing steps than an external conductor according to a conventional method that includes winding a metal braid or the like around the external conductor, followed by filling with melted metal for plating to densify the external conductor. Therefore, a productivity of the transmission cable can be improved, and a reduction in manufacturing cost can be achieved.

The insulating layer according to the present embodiment includes the isolated foam layer having isolated cells. Thus, a dielectric loss in the transmission cable can be decreased.

The signal transmission cable according to the present embodiment is composed of the above-described transmission cables. Accordingly, the signal transmission cable according to the present embodiment can ensure an improved electromagnetic shielding effect and stable impedance.

1. A transmission cable, comprising:
a base cable including at least one cable core having an internal conductor and an insulating layer provided on an outer periphery of the internal conductor and made of resin; and
an external conductor provided on an outer periphery of the base cable, wherein
the external conductor comprises:
a first conductor layer provided on the outer periphery of the base cable and made of an electrically conductive material; and
a second conductor layer provided an outer periphery of the first conductor layer and formed by electrolytic plating.

2. The transmission cable according to claim 1, wherein the first conductor layer is an electroless plating layer of copper, nickel or gold formed on the outer periphery of the base cable.

3. The transmission cable according to claim 1, wherein the insulating layer includes a first isolated foam layer.

4. The transmission cable according to claim 3, wherein
the insulating layer further includes a non-foam layer,
the first isolated foam layer is provided adjacent to the internal conductor, and
the non-foam layer is provided on an outer periphery of the first isolated foam layer.

5. The transmission cable according to claim 3, wherein
the insulating layer further includes a second isolated foam layer,
the first isolated foam layer is provided adjacent to the internal conductor,
the second isolated foam layer is provided on an outer periphery of the fir isolated foam layer, and
a degree of foaming of the first isolated foam layer is lower than that of the second isolated foam layer,

6. The transmission cable according to claim 3, wherein
the insulating layer further includes an interconnected foam layer,
the interconnected foam layer is provided adjacent to the internal conductor, and
the first isolated foam layer is provided on an outer periphery of the interconnected foam layer.

7. The transmission cable according to claim 1, wherein the insulating layer is made of polyolefin resin.

8. The transmission, cable according to claim 1, wherein the at least one cable core includes a plurality of cable cores.

9. A signal transmission cable comprising at least two transmission cables according to claim 1.
